(19) United States
(12) Patent Application Publication
(10) Pub. No.: US 2023/0310965 A1
(43) Pub. Date: Oct. 5, 2023

(54) Camera-Based System for Game Recognition

(71) Applicant: The Social Gaming Group IP B.V., Amsterdam (NL)

(72) Inventors: Frode Jacobsen, Oslo (NO); Bjørn-Gunvar Nessjøen, Strømmen (NO); Johannes Schuck, Oslo (NO)

(21) Appl. No.: 18/194,030

(22) Filed: Mar. 31, 2023

(30) Foreign Application Priority Data
Mar. 31, 2022 (NO) 20220397

(51) Int. Cl. A63B 71/06; A63B 67/14; G06T 7/246; G06T 7/73

(52) U.S. Cl. CPC A63B 71/0605; A63B 67/14; A63B 71/0622; A63B 71/0669; G06T 7/248; G06T 7/74; A63B 2220/05; A63B 2220/807; A63B 2225/15; G06T 2207/30204; G06T 2200/24; G06T 2207/30224; G06T 2207/30241

(57) ABSTRACT

A system for recognition of objects in a game, the system has a table with playing board for pucks on which the game is played, and reference markings distributed across the playing board that are used together with corner of the playing board in a surface mapping process. At least one area scan camera acquires images of the playing table during a game and reads fiducial marker of pucks that have the fiducial markers. The at least one area scan camera is arranged to cover the playing board and the reference markings. A processing unit processes the images acquired by the at least one camera.

### BACKGROUND

The invention relates to game recognition in general and more specifically a system for recognition of objects in a game.

The present invention relates to a method for executing steps for playing a game and a method for camera calibration accounting for lens distortion and image sensor parameters and a method for surface mapping.

Shuffleboard is traditionally played with metal and plastic weighted pucks pushed across a long, smooth wooden table. The surface is sprinkled with fine grained shuffleboard sand, silicone pellets or small balls, etc. in order to decrease friction of the pucks sliding across the table, as if the pucks glide on ball bearings across the table.

During the game, pucks are pushed towards a scoring area at the opposite end of the table. Points are scored when the pucks have stopped after crossing or approached certain lines or areas at the opposite end of the board. Each puck gets a higher score for each. In e.g., a two-player game the players can bump opposing pucks in order to get a better position of their own pucks or simply to push opposing pucks out of the game. A puck receives no points if it falls off or is bumped off the table. If a puck hangs partially over the end edge of the table, it receives points. The shuffleboard may have a setup enabling it to play the game from any of the two ends of the table.

Traditionally, the scoring is calculated at the end of the game when all pucks involved have been played. The points are calculated based on the position of the pucks on the board. Shuffleboard is played in pubs, arcades and entertainment centres etc., places where alcohol is served, and the scores are traditionally recorded manually at the end of the game and is often being subject to discussion. The discussion might be loud, lead to an argument or dispute, particularly when alcohol is involved.

In shuffleboard, there are various types of games having different set of rules, and new games with new set of rules are continuously being developed and adapted. Games that would require more complex set of rules may be harder to implement for players. As an example, if the score depends on the order of how the pucks are played, it would be far more difficult to keep track of the score. With eight or more pucks this might be challenging to the players to remember.

Systems for automatically recording scores in shuffleboard game exists, and from prior art one should refer to WO2018127677A1 describing a shuffleboard scoring system, the system comprises a shuffleboard with a sliding surface on which pucks can slide, a camera and a processor receiving and processing image data from the camera. The camera detects when a puck is moving and captures an image a first time followed by capturing an image of a stationary arrangement of the puck a second time. The processor determines if a puck is validly thrown and calculates a score based on the position of one or more pucks relative to the sliding surface at the second time. The puck is validly thrown if it has predetermined moving characteristics captured the first time, preventing players from placing pucks directly on the board. The system differentiates on colours of the pucks and the shape characteristics of the pucks at different positions on the board. It also recognizes whether it is a puck or not.

The system identifies the individual pucks using a tracking algorithm which takes a series of measurements derived from the camera images over time, to produce an estimate of its state. Even though tracking algorithms try to model statistical noise and other inaccuracies of the measured variables, the system can only estimate its actual state due to measurement errors in each timeframe. The uncertainty of the estimated state increases proportionally with the time foreign objects partially or fully occlude the measured objects in the camera image. This can lead to false scoring results. Occlusions are common source of error when deriving information from real world images, due to their unrestricted and complex nature.

The puck recognition bases its inference on appearance and geometrical attributes. Because the system has no way of verifying the correctness of the puck detection result, anything that looks similar to pucks (for example a red watch, or a blue drink) can produce false positives with a high likelihood.

There is therefore a need for a method and a system to overcome the above-mentioned problems.

### SUMMARY

In the following throughout the specification the following terms means:

The term “computer vision system” throughout this document is used to describe the software subsystem that runs computer vision and image processing algorithms and routines that analyses and finds objects on the table, based on images from one or more cameras.

The term “virtual model” used herein refers to a virtual representation of the playing surface and game objects on it.

The term “calibration” used herein refers to finding the intrinsic and extrinsic camera parameters.

The term “image templates” used herein refers to digital templates required to find regions of interest, typically playing board, in the surface mapping process.

The term “fiducial marker” used herein refers to markings on game objects (pucks) to identify them individually.

The term “coding scheme” used herein refers to the encoding of the fiducial marker.

The disclosed embodiments provide a camera-based system for recognition of objects in a game.

Also provided is a system for easy and reliable recording and calculation of score in a game.

Also provided is a system for instant feedback during the course of the game.

Also provided is a system comprising detection technology.

Another object is to provide unique identification of objects in a game.

Also provided is a board reconfigurable for a plurality of games and game features.

Also provided is an interactive interaction between the game participants and the board.

Also provided is a system configurable to other board games, such as chess, dart, billiard, etc.

According to the first aspect of the present invention, there is provided a system for recognition of objects in a game, the system comprising:
a table, wherein the table comprises;
a playing board for pucks on which the game is played;
reference markers distributed across the playing board that are used together with the playing board's corners in the surface mapping process;
at least one area scan camera for acquiring images of the playing table during a game, the at least one area scan camera arranged to cover the playing board and the reference markings;
a processing unit for processing the images acquired by the at least one camera;
the at least one camera reads a fiducial marker of pucks, wherein each puck comprises the fiducial marker.

In embodiments, the processing unit communicates with a user interface for game participants to initiate and choose games.

In embodiments, the user interface presents processed data from the processing unit about the game.

In embodiments, the user interface comprises a display.

In embodiments, the system comprises at least two area scan cameras.

In embodiments, wherein the fiducial marker is a RUNE-tag, and wherein the RUNE-tag comprises a plurality of circles distributed around the circumferences/edge of the puck or a puck cap to be arranged on the puck.

In embodiments, the playing board comprises scoring regions, the scoring regions being distributed across the playing board.

According to a second aspect, there is provided a method for executing steps for playing a game using the system above, the method comprises the steps of:
capturing at least one image of at least one puck on a playing board by means of at least one area scan camera;
unit;
transmitting the captured images to a computer vision processing
recognizing the fiducial marker of the at least one puck;
receiving puck positions and orientations of the at least one puck from the computer vision processing unit;
calculating a state and scoring of all pucks on the table based on the at least one puck positions or puck orientation.

In embodiments, the at least one area scan camera captures a plurality of images of the puck on the playing board in order to determine when the puck is in a steady state.

In embodiments, the method comprises the step of identifying a trajectory/path of the puck while moving across the playing board from throwing the at least one puck until it is in the steady state.

In embodiments, the method comprises the step of identifying a spin of the puck while moving by comparing the orientation of the fiducial mark from throwing the at least one puck until it is in the steady state.

In embodiments, an unwanted relative movement between the playing board and the at least one camera is detected by comparing reference points of the playing board with an initial position/relation between the playing board and the at least one camera.

In embodiments, the order of the game is communicated through a user interface.

According to a third aspect, there is provided a method for camera calibration of a playing surface of a system according to the above system accounting for lens distortion and image sensor parameters wherein a plurality of images of a checkerboard are captured while the camera and lens parameters stay constant.

According to a fourth aspect, there is provided a method for surface mapping (calibration of system) of the system, comprising the steps of:
capturing images of the table comprising corners and reference markings using at least one camera calibrated according to the method for camera calibration;
matching the captured image with image templates of coordinates of corners and reference points;
computing a transformation of the coordinates of the corners and reference points in the image;
mapping the coordinates from the image with the coordinates of the image templates.

In embodiments, a plurality of cameras captures images of the table, the plurality of cameras having overlapping views for generation of a full view of the playing board.

In embodiments, the method comprises the step of selecting a game on a user interface.

In embodiments, a projector projects a board image on the table appropriate for the selected game.

In embodiments, a projector projects the course of the game on a screen.

In embodiments, a projector projects the course of the game on the playing surface.

In further embodiments, the image may be a moving image.

The above-described characteristics and capabilities are accomplished by a set of components such as one or more area scan cameras that continuously acquire images of a board table surface while a game is being played. Line scan cameras may also be an option to detect that a puck has passed a line, e.g., in the middle of the playing board. Having high resolution cameras in the area where points are scored and lower resolution cameras in areas where scoring is not calculated.

In order for a straight line to appear straight in the camera image, the camera may need to be calibrated to account for intrinsic camera parameters such as focal length and lens distortion, as well as extrinsic parameters such as camera pose and transformation in relation to the shuffleboard. This process is called camera calibration and is usually performed by taking a series of images with the camera of a calibration pattern with known dimensions, like a planar checkerboard. It is required to be carried out once, as long as the camera and lens parameters stay constant.

The system determines the image coordinates of the corners of the playing board, as well as the line parameters which indicate the scoring regions. If the playing board is captured with a plurality of cameras, it uses the coordinates of additional reference points on the playing board that are visible in the images taken by two or more different cameras with overlapping views to generate a full view of the playing board by stitching the images together. From the coordinates of the corners and reference points in an image a transformation is computed that mathematically describes the mapping from image coordinates to coordinates in a virtual model of the playing surface. We call this process playing surface mapping.

The system will perform the playing surface mapping, preferably at the beginning of the game, but it does not exclusively have to be at the start.

Performing player surface mapping, the system's software uses small image templates of the corners and reference points to match them on the images. Ideally, the templates match on the image acquired by the camera during the surface mapping process, therefore the process is performed automatically without the need for manual configuration. In cases where the automatic surface mapping process fails due to a low match score of a corner or reference points template with the image used for surface mapping, the intervention of a human is required.

Depending on the reasons for the failure, different measures can be taken:
a. If the failure is related to physical setup, an operator needs to take actions accordingly. Possible failures may be, but not limited to, foreign objects that occlude points of interest, displaced or damaged equipment like the table, playing surface or cameras.
b. If the failure is related to a change in illumination compared to the conditions when the template image was acquired, the templates can be updated by the operator.
c. If the failure is software related, the matching algorithm of the software needs to be updated by a software developer.

The pucks are being detected using computer vision algorithms and their identity is verified using a fiducial marker which is printed on top of them.

The coordinates of a puck in the virtual model are acquired by interpolating its image coordinates between the coordinates of the surface corner and reference points.

To determine the score of the pucks on the playing board, their position in the virtual model is used and calculated with respect to the rules of the game that is played.

The playing participants of a game can choose which game to be played, and the system recognizes the course of the game and gives feedback through a display, monitor or projector on that given game.

The interface displaying the course of the game can either show the image obtained by the cameras of the board or use a virtual model to create a digital representation of the board and given game to be played.

During the course of the game, the system recognizes when a puck is thrown and tracks the movement until it finds its position, either on the playing surface or if it has fallen off by being bumped off it by another puck.

The system recognizes individual pucks using fiducial markers that encode a bit sequence. A fiducial marker is an artificial object consistent with a known model that is placed in a scene. This ability to recognize the viewed markers is very important for complex scenes where more than a single fiducial is required, like on a shuffleboard surface. The coding scheme of the fiducial marker allows for an additional validation step and lowers the number of false puck detections. Instead of relying on just the puck colour, a certain set of circular binary codes may be considered valid combinations. In addition, the circular code on the puck contains an error correction code which detects if a bit in the binary sequence that has been read has been flipped, for example by damage to the fiducial marker or occlusion.

Fiducial markers are used to recognize individual pucks in a scene by the processing unit. It is also possible for the user to recognize the fiducial markers if they have simple geometry, such as squares vs. circles, triangles etc. or by background and/or foreground colour of the fiducial marker.

It is possible to track the pucks across the whole table and for the whole throw, allowing more advanced gameplay that takes this into account. For example, by introducing a virtual gate that the player has to throw the puck through and determine if the puck went inside or outside the gate.

An example of a fiducial marker is circular markers based on the well-known RUNE-tag, where white and/or black circles are alternated around the edge/circumferences of the puck cap, a few bits of information can be encoded in the markers itself. This sequence of bits is decoded by the system to obtain the identity of each puck.

Another example of markers are larger geometric shapes like squares and triangles. In this case the processing unit needs to track each individual puck as they enter the playing area. This requires high acquisition frequency (high frame rate). It is also sensitive to occlusion because each puck no longer has a unique fiducial marker. A variation of such shapes to be printed on the puck to be visualized while picking a puck and placing it on the game surface on a given players turn.

Fiducial markers are used to establish a visual reference in a scene and can aid camera calibration, localization, tracking, mapping, object detection etc.

As a pre-processing step, and in order to maintain high frame rate for a smooth game experience for the players, colour filtering can be utilized to speed up the fiducial marker processing time. Instead of searching the whole image for a fiducial marker by looking for patterns after applying an edge detection algorithm, potential regions of interest can be found by filtering by the puck cap's colour. By filtering the region of interest with colour, only a fraction of the image vs. the whole image is analysed, and thus less computational time is required. It is important that the colours of the pucks differentiate from other colours on the board table. The size, shape and dimension of the pucks may also be used to differentiate. Thus, by utilizing the fast colour filtering for detecting pucks, and thereafter reading the fiducial marker to get more information about the specific puck increases the accuracy of the recognition while reading pucks.

Further fiducial markers can be combined with pucks having the ability to change colour based on feedback from the game. When the player picks up a puck and places it in front of him/her on the game surface, the puck can simply take on the correct colour assigned to that player, e.g., green, red, yellow, blue etc.

The pucks can also have built in gyro or accelerometers detecting e.g., collisions, and the puck may take another colour, brighter colour, or glow brighter when colliding, e.g., by means of LED-lights.

The pucks may comprise LED-lights, shining bright enough to look white in the images. No extra lighting above the game surface is needed and a light fixture can be excluded leaving room for other equipment or relocation of other equipment. For example, a TV or cameras can be moved higher up. Cameras located higher up can cover a larger area and more of the area furthest away from the camera, the number of cameras can thus be reduced. Where 4 cameras were required to cover the table, now two cameras can be sufficient by angling the cameras correctly to cover the table. This further reduces complexity and increases the reliability and frame rate. Having a dark playing surface, pucks lit up by LED have a sharp contrast to the playing surface, and the system does not have to rely heavily on colour filtering or marker matching, but can look for shapes fitting predetermined sizes along the playing surface.

The pucks may communicate via Bluetooth for example to tell which colour to take.

The shuffleboard puck consists of two parts: the lower part is usually made from polished metal and the upper part is a plastic cap that is screwed on top. The player or team is identified by the colour of the puck cap or the geometrical shapes printed on the puck cap. Puck caps usually have a logo printed in the centre, which also acts as a grip area for the player's thumb. Using a circular fiducial marker around their outer edge allows for the placement of a logo in the centre of the puck.

Other fiducial marker systems use the centre area to encode information, while some markers, like ARToolkit, use image correlation to differentiate markers. Other systems like ARTag, AruCo (DOI:10.1016/j.patcog.2015.09.023) or QR-codes rely on error-correcting binary codes and thus require flat puck caps in order to place them onto a puck. Placing these fiducial markers in the small hole in the centre of a standard puck cap does not allow for robust identification given the camera's sensor resolution, lens optics quality and distance of the camera(s) to the playing surface used in an economic setup applicable to commercial applications.

The puck positions on the playing board acquired by the vision system from frame to frame can be used to project the path of the puck and visually present it in an interface communicating with the player(s). The frame rate of the camera and the number of frames per second of the marker IDs are read may be lower than the visualization frame rate displayed to the user. Therefore, the visualization interpolates the puck movement path so that it looks stutter free for a human.

The trajectory and speed of each puck is the delta of the puck's position in two subsequent frames. The trajectory can also be used to identify eventual collisions that otherwise remain unseen due to the limited framerate of the camera or speed of the vision algorithms. In the same manner the spin of the puck may be identified by comparing the orientation of the fiducial marker on the puck in two subsequent frames. The identified spin can be used in virtual animations on the screen or to judge the level of competence of the player or of the throw of the puck.

If the camera or table moves either temporarily as a result of trembling, or more permanent if the camera is physically moved, the relative movement between the camera and table can be detected and corrected by calibration. The corners or reference points are regularly or before every game or throw compared in order to detect if they have moved compared to the initial position.

The rules and turns of the game can be communicated or managed through a user interface. Suitable user interfaces include one of or a combination of e.g. touch screen, screen, keyboard, physical switches, projectors, light, sound, cameras, etc.

The inventive embodiments disclosed herein are advantageous over the prior art because the provide capacity to identify pucks individually without relying on tracking algorithms or colour information. Because the playing field is monitored by at least one camera with sufficient resolution, games with a more complex set of rules can be implemented on the system.

The system has the advantage being configurable with a plurality of different games having alternate sets of rules and visualizations. These games are not static and can be adjusted, added, upgraded, updated, and reconfigured with new sets of rules, instructions, and visualizations.

In the following, examples of games that can be played are given. The base game, Shufl, which is similar to a traditional game of shuffleboard where player's score points by placing the puck as close to the edge of the other side of the table as possible. The system tracks the pucks, keeps score, and makes the overall experience uniquely care-free. Another game, Conquer, has an entirely different set of rules where players place pucks on the board to “take over” sections of it to score points. The board becomes a battlefield, and the system not only keeps score but also shows which team owns what territory so that players can make strategic decisions on where to place their pucks. This game would be near impossible to play without the technology underpinning it. This is just an inexhaustible list of the variety of types of games the invention can support.

The embodiments also provide mechanisms for displaying unique graphics and a set of pre-programmed games. The pre-programmed options of games to be played, graphics etc. can be updated and upgraded to a variety of new options. Either new developed games or the system can be sold with a variety of options or game packages, depending on market and end customer.

### BRIEF DESCRIPTION OF THE DRAWINGS

The above and further features of the invention are set forth in the following detailed description of a non-limiting exemplary embodiment given with reference to the accompanying drawings.

The invention will be further described below in connection with exemplary embodiments which are schematically shown in the drawings, wherein:

FIG. 1 shows a system for recognition of objects in a game.

FIG. 2 shows a top view of a playing surface with score markings, pucks and reference points.

FIGS. 3A-3C show different exemplary fiducial marker alternatives for various puck caps.

The following reference numbers and signs refer to the drawings:

TABLE 1

| | |
|---|---|
| 100 | Table |
| 110 | Playing board |
| 120 | Crate |
| 130 | Score markings/scoring regions |
| 140 | Reference markings |
| 200 | Puck |
| 210 | Fiducial marker |
| 300 | Camera |
| 400 | Lighting fixture |
| 500 | Touch screen/User interface |
| 510 | Displays for game information |
| | and visualizations |
| 600 | Processing unit/computer |

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The inventive embodiments will be further described in connection with exemplary embodiments which are schematically shown in the drawings.

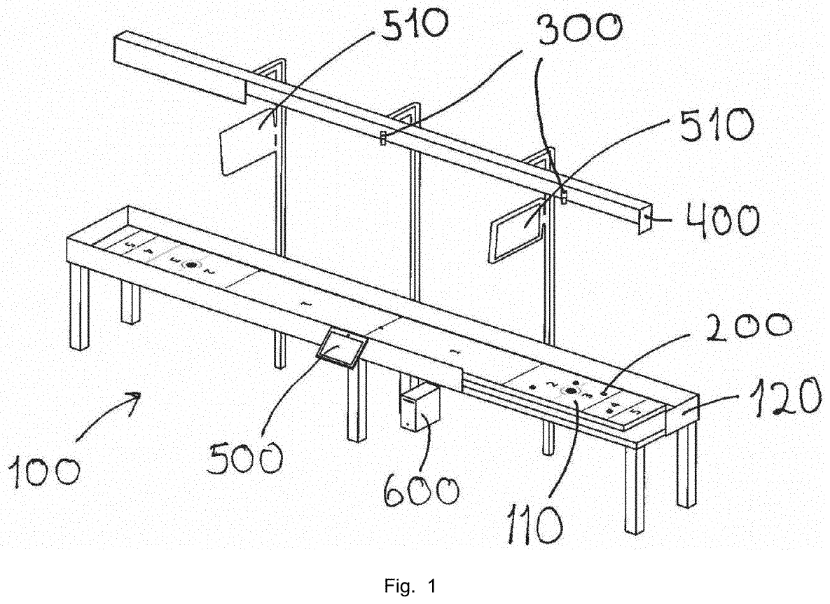

FIG. 1 shows a system for recognition of objects in a game comprising a table or court 100 comprising a playing surface 110 on which the game is played. A puck 200 is shown on the table or court 100. A camera 300 is positioned above the table or court 100 in a position where it can capture images of the whole top surface of the table or court 100. FIG. 1 shows one camera, but it is not limited to camera, it might have more cameras, preferably two or three cameras. User interfaces 500 and monitors or projectors 510 are used for interaction between the game participant and a processing unit 600 controlling the course of the game. The game participants can choose what game set up to play and the course of the game will be communicated through monitors or projectors 510. Images will be captured throughout the game and processed in the control unit. The control unit calculates and sends information about scoring, course of the games etc. and communicates to the game participants through the monitors or projectors 510.

The key components of the system comprise the table 100 comprising a playing board 110 and a crate 120. Where the crate 120 is the structure surrounding the playing board 110 and receives the pucks falling off the playing board 110 together with the shuffleboard sand. The pucks 200 are tracked by one or more area scan cameras 300 such that their fiducial markers 210 can be read on the whole playing surface 110. The computer vision algorithms that process the image are executed on a processing unit 600. The processing unit 600 is operatively connected with the camera, processing images captured by the camera. Players can interact with the system through a user interface 500 preferably using a touchscreen. Based on the current game rules the scores and other visualizations are presented to the user on one or more screens, displays or projectors 510.

The user interface 500 is configured as an input device to detect game options selected by a user. The user selects or chooses between a set of pre-programmed game options from a menu allowing the user to e.g. select between different game types, levels, graphics, etc. and to initiate the start of the game. The monitor or projector 510 displays game information prior to and during the course of the game and at the end of the game. The game information displayed is dependent on where in the course of the game being at any given time, and the given information can span from information on when to throw a puck 200, who to throw a puck 200, the path of the puck 200, the end position of the puck 200, information on a previously thrown puck 200 being hit and follow the new path of puck 200 being hit, scorings during the game and final scoring results, the information to be communicated on said monitor or projector 510 may comprise an inexhaustible pre-programmed information to be communicated.

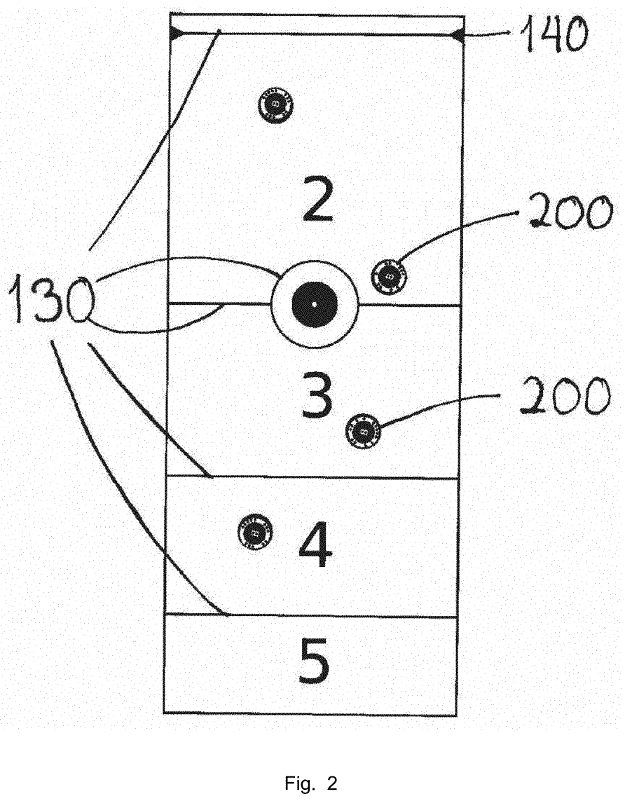

The top surface of the playing board 110 comprises a set of scoring segments or scoring lines. FIG. 2 shows a top view of a playing surface with score markings, 130 pucks and reference points or markings 140, the playing board 110 is not limited to such a setup of score markings 130 and reference points or markings 140 as shown in FIG. 2 but may have any given setup. The system is usually pre-programmed to a given setup of score markings 130 and reference points or markings 140. Within a given setup it may be possible to play a range of different pre-programmed games and/or the system may be reloaded or updated with a set of new gaming features or implement new rules or games. In FIG. 2 is shown a plurality of pucks 200 either shown during the course of the game, or it shows the final position when the last puck 200 is thrown and the game is finalized. The at least one camera 300 captures images during the game, starting with at least one image where the user has initiated the game through the user interface 500. During the game, at least one camera 300 captures images initiated when a puck is thrown and/or captures a plurality of images during the game.

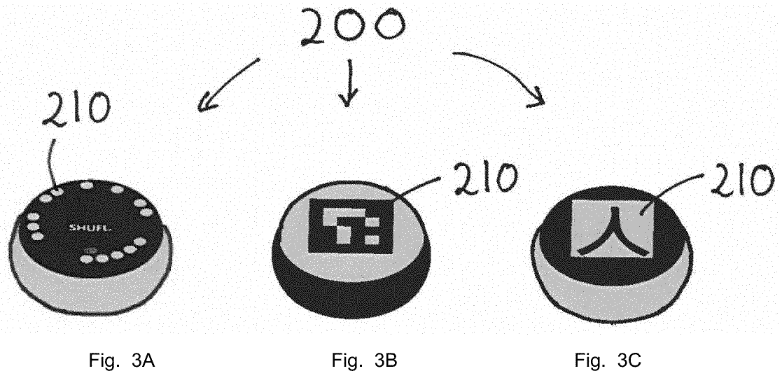

FIGS. 3A-3C show different fiducial marker 210 alternatives for various puck caps. The different unique fiducial markers 210 may be placed directly on a top surface of a puck 200 or a puck 200 may be provided with a cap having such unique fiducial marker 210. FIG. 3A shows a puck cap with a typical RUNE-tag, where a plurality of white or any other given colour, i.e., black, red, green, etc. circles are alternated around the edge or circumference on a top surface of the puck 200. For individual recognition of each individual puck in a game, the plurality of circles may have its unique distribution alternated on each individual puck. The RUNE-tag is not limited to be marked by a plurality of circles, it may have shapes of squares, stars, etc. It is not limited to alternate around the edge or circumference of the top surface of the puck 200, but may find its position between the edge or circumference to the centre of the puck 200. When alternated around the edge or circumference, the centre of the puck 200 may comprise other information such as logos, colour identification in order for the user to visually identify his or her puck, etc. Or such information may be displayed on the edge or circumference in the case where the markers (circles) are arranged closer to the centre of the puck 200.

With markers alternated around the edge or circumference, a logo can be integrated into the fiducial marker.

FIG. 3B shows a puck with a ARTag marker and FIG. 3C shows a puck with an ARToolkit marker. The black square border in both ARTag and ARToolkit enables detection, but while ARToolkit uses image correlation to differentiate markers, ARTag relies in error-correcting binary codes and uses image correlation for marker identification. However, the small area in the centre of the puck does not allow for robust identification given the resolution and optics of cameras used for cost-effective setups.

To obtain sharp images of moving objects with a camera 300 a short exposure time is required. To make sure enough light hits the image sensor, artificial lighting 400 may be required. This way the fiducial marker 210 identity can be read while the puck 200 is moving. This allows for a smooth game experience for the players, by keeping the visualization on the monitors 510 synchronized with the real puck positions in real time.

When using a plurality of cameras 300, their digital images may be stitched together using the reference markings 140 for the surface mapping process.

In embodiments, to automate the software setup and increase robustness, the camera position may be determined by detecting certain features, such as corners or centre logos on the left or right of the table 100.

In embodiments, the cameras 300 can be used to detect gestures as a user interface during game play. When the user holds a puck, the system knows that it is held by a legitimate user. With a gesture such as a circle the system knows that the puck is not thrown and a menu can be projected on to the gaming surface. The user can move the puck to interact with the projected menu.

In embodiments, a projector can be used to project the game onto the playing surface. This takes away the need of monitors to show the game progression and will make the games more immersive.

In embodiments, smart pucks can have embedded LEDs and sensors that receive a command from the game machine, processing unit, computer or the like to determine what colour the LED light should have, and change colour based on game mode, which team is playing, etc. The LED-light is controlled by a microcontroller positioned within the smart puck. Using a built-in accelerometer or gyro, the smart puck can detect collisions and change brightness of the LED-light based on this.

What is claimed is:

1. A system for recognition of objects in a game, the system comprising:
a table (100), comprising
a playing board (110) for pucks (200) on which the game is played, the playing board (110) having sides and corners and defining a surface;
reference markings (140) distributed across the playing board (110) that are used together with the corners of the playing board (110) in a process for surface mapping;
at least one area scan camera (300) arranged to cover the playing board (300) and the reference markings (140) for acquiring images of the playing board (110) during a game;
a processing unit (600) for processing images acquired by the at least one camera (300), wherein
each puck (200) comprises a fiducial marker (210), and
the at least one camera (300) reads the fiducial marker (210) of the pucks (200).

2. The system according to claim 1, wherein the processing unit (600) communicates with a user interface (500) for game participants to initiate and choose games.

3. The system according to claim 2, wherein the user interface (500) presents processed data from the processing unit (600) about the game.

4. The system according to claim 2, wherein the user interface (500) comprises a display (510).

5. The system according to claim 1, wherein the system comprises at least two area scan cameras (300).

6. The system according to claim 1, wherein the fiducial marker (210) on at least one puck (200) is a RUNE-tag comprising a plurality of circles distributed around an outer edge of the puck (200) or a puck cap configured to be arranged on the puck (200).

7. The system according to claim 1, wherein the playing board (110) comprises scoring regions (130) distributed across the playing board (110).

8. A method for executing steps for playing a game using a system according to claim 1, comprising the steps of:
capturing at least one image of at least one puck (200) on a playing board (110) via at least one area scan camera (300);
transmitting the captured images to a computer vision processing unit (600);
recognizing the fiducial marker (210) of the at least one puck (200);
receiving puck positions and orientations of the at least one puck from the computer vision processing unit (600);
calculating a state and scoring of all pucks (200) on the table (100) based on the at least one puck positions or puck orientation.

9. The method according to claim 8, wherein the at least one area scan camera (300) captures a plurality of images of the puck (200) on the playing board (110) in order to determine when the puck (200) is in a steady state.

10. The method according to claim 9, comprising a step of identifying a trajectory or path of the puck (200) while the puck (200) moves across the playing board (110) from throwing the at least one puck (200) until it is in the steady state.

11. The method according to claim 9, comprising a step of identifying a spin of the puck (200) while moving by comparing the orientation of the fiducial mark (210) from throwing the at least one puck (200) until it is in the steady state.

12. The method according to claim 9, wherein an unwanted relative movement between the playing board (110) and the at least one camera (300) is detected by comparing reference markings (140) of the playing board (110) with an initial position or relation between the playing board (110) and the at least one camera (300).

13. The method according to claim 9, wherein an order of the game is communicated through a user interface (500).

14. A method for surface mapping of a system according to claim 1, comprising the steps of:
capturing images of the table comprising corners and reference markings (140) using at least one camera (300) that is calibrated to account for lens distortion and image sensor parameters;
matching the captured image with image templates of coordinates of corners and reference markings (140);
computing a transformation of coordinates of the corners and reference markings (140) in the image;
mapping the coordinates from the image with the coordinates of the image templates.

15. The method of claim 14, wherein the at least one camera is calibrated via capturing a plurality of images of a checkerboard while the camera and lens parameters stay constant.

16. The method according to claim 14, wherein a plurality of cameras (300) capture images of the table, the plurality of cameras having (300) overlapping views for generation of a full view of the playing board (110).

17. The method according to claim 14, comprising a step of selecting a game on a user interface (500).

18. The method according to claim 17, wherein a projector projects a board image on the table appropriate for the selected game.
